(19) United States
(12) Patent Application Publication
(10) Pub. No.: US 2019/0334436 A1
(43) Pub. Date: Oct. 31, 2019

(54) METHOD FOR BALANCING LOSS ENERGY DISTRIBUTION IN A CIRCUIT DRIVING A RESONANT LOAD

(71) Applicant: Unico, LLC, Franksville, WI (US)

(72) Inventor: James Frank Lousier, Racine, WI (US)

(73) Assignee: Unico, LLC, Franksville, WI (US)

(21) Appl. No.: 15/965,299

(22) Filed: Apr. 27, 2018

(51) Int. Cl. H02M 3/155; C01B 13/11

(52) U.S. Cl. CPC H02M 3/155; C01B 2201/90; C01B 13/115

(57) ABSTRACT

A method is disclosed for balancing loss energy distribution in a drive circuit which drives a resonant load. The method includes the steps of using a plurality of switches to modulate a flow of electrical energy to a resonant load, and providing each of the plurality of switches with a diode connected in anti-parallel to its respective switch. The method further includes generating a voltage-modulated waveform across the resonant load which results in a first amount of loss energy distributed equally among the plurality of switches, and a second amount of loss energy distributed equally among the diodes.

### FIELD OF THE INVENTION

This invention generally relates to a method for driving a resonant load.

### BACKGROUND OF THE INVENTION

Electrical circuits with resonant loads are used in a variety of applications from ozone generation, to induction heating, contact welding, and radio transmission. In some cases, power is supplied to the resonant load via a drive circuit configured to enable the efficient conversion of energy from a DC power supply to the resonant load.

Not surprisingly, it is desirable to operate drive circuits for resonant loads with the highest possible efficiency. Inefficient drive circuits may result in larger power supplies, and the drive circuits may waste a significant amount of power in the form of heat. Generally, these drive circuits include switches for regulating the power delivered to the resonant load. Often, these switch elements are power semiconductor devices. As a result of the aforementioned inefficiency, the drive circuit may use switches larger than would otherwise be necessary to reduce the likelihood of failure due to overheating. Further, the drive circuit could also require large heat sinks and/or cooling fans for heat removal, and are often less reliable as a result.

In drive circuits that employ such switching systems, the switching frequency may also have an effect on the overall efficiency of the system. Higher switching frequencies tend to decrease power efficiency and cause greater stress on the switching element. As referenced above, increased switching losses may result in switching element damage due to overheating. System stability and reliability is adversely affected as a result.

It would be desirable to have a system for driving resonant loads which improves on the conventional systems described above. Embodiments of the present invention provide such a system. These and other advantages of the invention, as well as additional inventive features, will be apparent from the description of the invention provided herein.

### BRIEF SUMMARY OF THE INVENTION

In one aspect, embodiments of the invention provide a method for balancing loss energy distribution in a circuit driving a resonant load. The method includes the steps of using a plurality of switches to modulate a flow of electrical energy to a resonant load, and providing each of the plurality of switches with a diode connected in anti-parallel to its respective switch. The method further includes generating a voltage-modulated waveform across the resonant load which results in a first amount of loss energy distributed equally among the plurality of switches, and a second amount of loss energy distributed equally among the diodes.

In a particular embodiment, implementing the voltage-modulated waveform across the resonant load includes implementing the voltage-modulated waveform across the resonant load using an H-bridge circuit having a left leg and a right leg. The resonant load is connected to respective central junctions of the left and right legs.

In a further embodiment, implementing the voltage-modulated waveform across the resonant load using an H-bridge circuit includes generating a first voltage waveform at the central junction of the left leg, and generating a second voltage waveform at the central junction of the right leg. The second voltage waveform is a mirrored pattern of the first voltage waveform.

In certain embodiments, using a plurality of switches to modulate a flow of electrical energy to a resonant load includes using four switches to modulate a flow of electrical energy to a resonant load. The method may further include the step of using a controller configured to control the plurality of switches and programmed to generate the first voltage waveform and the second voltage waveform. Additionally, using a plurality of switches to modulate a flow of electrical energy to a resonant load may include using a plurality of switches to modulate a flow of electrical energy to an ozone generator. In some embodiments, using a plurality of switches to modulate a flow of electrical energy to a resonant load includes using a plurality of transistors to modulate a flow of electrical energy to a resonant load.

In another aspect, embodiments of the invention provide a drive circuit for driving a resonant load. The drive circuit includes a plurality of switches to modulate a flow of electrical energy to a resonant load. Each of the plurality of switches has a diode connected in anti-parallel. A resonant load is coupled to the switches such that the switches modulate a flow of electrical energy to the resonant load. A controller is coupled to the switches, and the controller is configured to operate the plurality of switches such that a first amount of loss energy is distributed equally among the plurality of switches, and a second amount of loss energy is distributed equally among the diodes.

In a particular embodiment, the plurality of switches and associated diodes are arranged to form an H-bridge circuit with a left leg and a right leg, the resonant load being connected to respective central junctions of the left and right legs. In a further embodiment, the plurality of switches includes no more than four switches.

In certain embodiments, the controller is configured to operate the plurality of switches to generate a first voltage waveform at the central junction of the left leg, and to generate a second voltage waveform at the central junction of the right leg, wherein the second voltage waveform is a mirrored pattern of the first voltage waveform. The resonant load may be an ozone generator. Further, the plurality of switches may include a plurality of transistors.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a schematic representation of a drive circuit for a resonant load, according to an embodiment of the invention;

FIGS. 2A and 2B are graphical illustrations showing the current and voltage waveforms seen by the resonant load and by the switches and diodes of a conventional drive prior art circuit; and

FIGS. 3A and 3B are graphical illustrations showing the current and voltage waveforms seen by the resonant load and by the switches and diodes of a drive circuit constructed in accordance with an embodiment of the invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

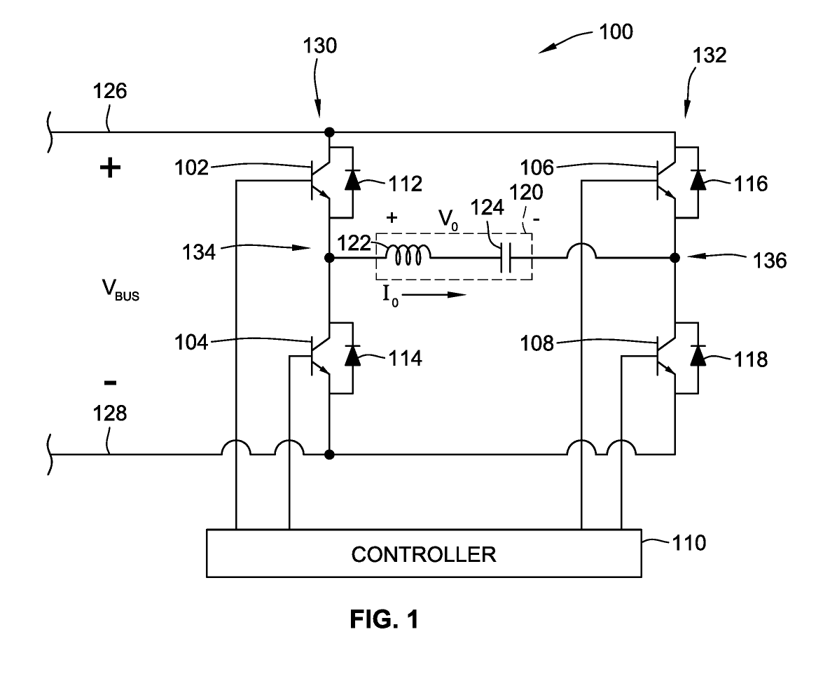

FIG. 1 is a schematic representation of a drive circuit for a resonant load, according to an embodiment of the invention. The exemplary drive circuit 100 of FIG. 1 includes first switch 102, second switch 104, third switch 106 and fourth switch 108. In the embodiment shown, the switches are transistors. In specific embodiments, the switches are power semiconductor transistors or, more broadly, power semiconductor switches. Each of the four switches 102, 104, 106, 108 has a diode connected in anti-parallel. The four respective diodes 112, 114, 116, 118 provide a path for electrical current when the diode's respective switch is open.

A controller 110 controls each of the four switches 102, 104, 106, 108 allowing for control of the voltage across, and current through, a resonant load 120. In FIG. 1, the resonant load 120 is represented schematically by an inductor 122 in series with a capacitor 124. In the embodiment shown, power to the resonant load 120 is provided via a DC bus that includes positive bus line 126 and negative bus line 128.

The four switches 102-108 are arranged in an H-bridge circuit configuration having a left leg 130 and a right leg 132. The resonant load 120 is connected between the left and right legs 130, 132. Specifically, one terminal of the resonant load 120 is coupled between the first switch 102 and second switch 104 at a first central junction 134 between the two switches 102, 104. The other terminal of the resonant load 120 is coupled between the third switch 106 and fourth switch 108 at a second central junction 136 between the two switches 106, 108.

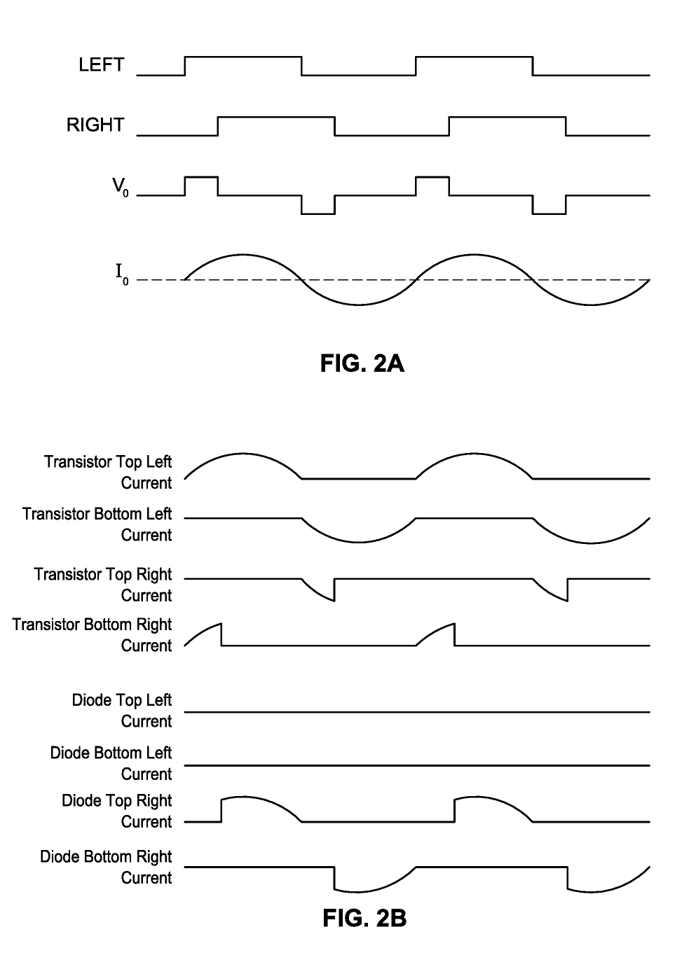

FIG. 2A illustrates voltage and current waveforms across the resonant load 120 where the power is provided by a conventional H-bridge drive circuit, while FIG. 2B illustrates the various energy losses in the transistors and diodes in a conventional drive prior art circuit. In this context, “conventional” refers to the control scheme for the switches. Conventional drive circuits may have a similar H-bridge configuration as shown in FIG. 1, but lack the controller 110 configured to operate the switches in a manner that equally distributes energy losses among the switches and diodes. Conventional control schemes generate voltage “V_{O}” by producing the right and left leg voltages shown in FIG. 2A which are described below.

In a conventional drive circuit for a resonant load 120, the current flowing through the resonant load 120 is shown by the sinusoidal wave “I_{O}”. In this case, “I_{O}” represents the steady-state current flow in a resonant circuit in addition to the current flow attributable to the voltage pulse “V_{O}”, which represents energy added to the resonant load 120 in addition to that used to establish a steady-state current flow. The voltage across the resonant load 120 is shown by the square wave “V_{O}”. The voltage, “V_{O}”, is determined by the voltage at a central junction, corresponding to the first central junction 134 in FIG. 1, of the left leg 130, and a central junction, corresponding to the second central junction 136, of the right leg 132.

In FIG. 2A, the left leg voltage at a central junction, akin to first central junction 134 in FIG. 1, is shown by the square wave, LEFT. The right leg voltage at a central junction, akin to the second central junction 136 in FIG. 1, is shown by the square wave, RIGHT. The difference between the LEFT and RIGHT voltages determines the voltage, V_{O}. Furthermore, the phase shift, between the LEFT and RIGHT voltages, determines the width of the positive and negative pulses of V_{O}. The width of these pulses determines the amount of energy added to the resonant circuit from each pulse.

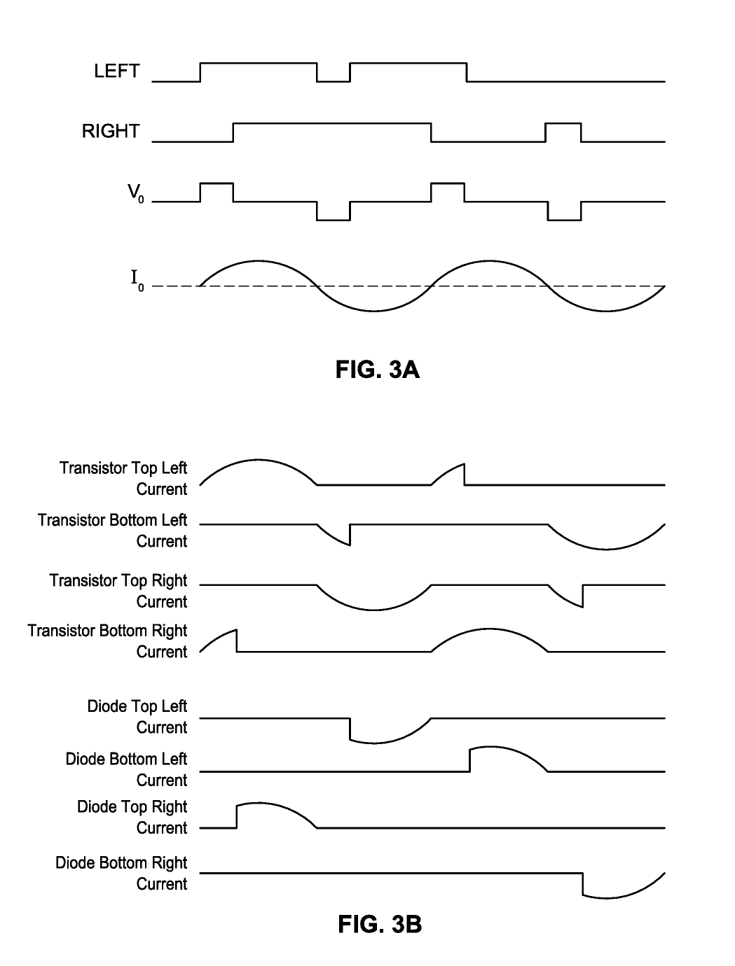

The sinusoidal current waveform “I_{O}” represents the oscillating current of the resonant load 120. The distribution of loss energy between the various transistors and diodes in the H-bridge circuit may vary based on the phase difference between the “I_{O}” and “V_{O}” waveforms. Specifically, the difference between the timing of the low-to-high transition in the positive pulse of the “V_{O}” waveform and the zero-crossing of the “I_{O}” waveform can determine the extent of the unequal loss energy distribution between the switches and diodes of the H-bridge circuit. In many cases, the maximum unequal loss distributions occur at the most desirable time for initiating a voltage pulse, e.g., starting the voltage pulse at the zero crossing of the current waveform. This is in contrast to the present invention in which the controller 110 is programmed to generate LEFT and RIGHT waveforms (see FIG. 3B) which provides equal loss energy distribution among the transistors 102-108 and diodes 112-118 of the drive circuit 100 irrespective of the phase difference between the “I_{O}” and “V_{O}” waveforms.

Referring again to the waveforms of a conventional drive circuit shown in FIG. 2A, when the top left 102 and bottom right 108 switches (see FIG. 1) in the H-bridge circuit are both closed, i.e., their transistors are on, and the top right 106 and bottom left 104 switches in the H-bridge circuit are both open, i.e., their transistors turned off, the voltage “V_{O}” goes positive (see +V_{Bus} in FIG. 1). When the top right 106 and bottom left 104 switches in the H-bridge circuit are both closed, and the top left 102 and bottom right 108 switches in the H-bridge circuit are both open, the voltage “V_{O}” goes negative (see −V_{Bus} in FIG. 1).

When the bottom left 104 and bottom right 108 switches in the H-bridge circuit are both closed, and the top left 102 and top right 106 switches in the H-bridge circuit are both open, the voltage “V_{O}” is zero. Similarly, when the bottom left 104 and bottom right 108 switches in the H-bridge circuit are both open, and the top left 102 and top right 106 switches in the H-bridge circuit are both closed, the voltage “V_{O}” is zero.

The waveforms of FIG. 2B show the amount of current flowing through the four transistors and four diodes of the H-bridge circuit. As can be seen, the amount of current, and therefore loss energy dissipated by each of the transistors is not equal in all transistors. Similarly, there are unequal amounts of loss energy dissipated in the four diodes. The result of this unequal distribution of loss energy is that those transistors and diodes with the highest rates of energy dissipation are likely to fail sooner than those with lower rates of energy dissipation, and also limits the amount of power that can be delivered to the load. Additionally, for those instances where it is desired to supply the resonant load 120 with high levels of electrical energy, conventional systems must be constructed so that all transistors and diodes are designed to withstand the highest rates of energy dissipation. The inclusion of larger diodes and switches, which in certain embodiments include power semiconductor transistors such as insulated-gate bipolar transistors (IGBT), may add significantly to the cost and size of the drive circuit 100.

In accordance with an embodiment of the invention, FIG. 3A illustrates voltage and current waveforms across the resonant load 120, while FIG. 3B illustrates the various energy losses in the transistors and diodes in the drive circuit 100 of FIG. 1. As in FIGS. 2A and 2B, the current flowing through the resonant load 120 is shown by the sinusoidal wave I_{O}. Similarly, the voltage across the resonant load 120 is shown by the square wave V_{O}. The voltage “V_{O}” is determined by the voltage at the first central junction 134 of the left leg 130, and at the second central junction 136 of the right leg 132.

In FIG. 3A, the left leg voltage at first central junction 134 in FIG. 1, is shown by the square wave, LEFT. The right leg voltage at second central junction 136 in FIG. 1, is shown by the square wave, RIGHT. The difference between the LEFT and RIGHT voltages determines the voltage, V_{O}.

When the first and fourth switches 102, 108 (see FIG. 1) are both closed, and the second and third switches 104, 106 are both open, the voltage “V_{O}” goes positive. When the second and third switches 104, 106 are both closed, and the first and fourth switches 102, 108 are both open, the voltage “V_{O}” goes negative.

When the second and fourth switches 104, 108 are both closed, and the first and third switches 102, 106 are both open, the voltage “V_{O}” is zero. Similarly, when the second and fourth switches 104, 108 are both open, and the first and third switches 102, 106 are both closed, the voltage “V_{O}” is zero.

The waveforms of FIG. 3B show the amount of current flowing through the four transistors and four diodes of the drive circuit 100 of FIG. 1. As can be seen, the amount of current, and therefore loss energy dissipated by each of the transistors is substantially equal among all four transistors. Similarly, FIG. 3B shows that the amount of loss energy dissipated by each of the diodes is substantially equal among all four diodes. Equally distributing the loss energy among the transistors and diodes will increase reliability of the drive circuit 100 and allow for sizing all of the components consistently to minimize cost and maximize efficiency, while maintaining the compactness of the drive circuit 100, and getting the most power to the load without derating, i.e., providing larger and more expensive diodes and switches than required by the drive circuit 100 of FIG. 1.

The controller 110 of FIG. 1 operates the four switches 102-108 to produce the waveforms LEFT and RIGHT in FIG. 3A. The controller 110 is programmed such that the LEFT waveform is a mirrored pattern of the RIGHT waveform. In the context of the present invention, “mirrored pattern” refers to the relationship between the LEFT and RIGHT waveforms as described below.

As can be seen in FIG. 3A, the LEFT waveform has two positive pulses (i.e., two low-to-high transitions) in fairly rapid succession, followed by a relatively long period at the low voltage before a final low-to-high transition. The RIGHT waveform, starting at the low voltage, transitions from low to high for the same relatively long period mentioned above, then has two high-to low transitions in fairly rapid succession before a final low-to-high transition. Thus each waveform has the same transitions but in the opposite direction, and the timing of those transitions is mirrored in that, for example, the two transitions in rapid succession occur at the beginning of one waveform (LEFT) and at the end of the other waveform (RIGHT). The result is the V_{O} waveform of FIG. 3A showing two positive pulses and two negative pulses over two resonant cycles.

The controller 110 is programmed with specific times for the opening and closing of the four switches 102-108 in order to get the desired frequency and produce the mirrored pattern waveforms shown in FIG. 3B in order to equally distribute loss energy among the transistors and diodes. This is in contrast to control schemes of conventional prior art drive circuits in which only the phase difference between the left leg and right leg voltages are controlled, and no mirrored pattern for the left leg and right leg waveforms is generated.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for balancing loss energy distribution in a circuit driving a resonant load, the method comprising the steps of:
using a plurality of switches to modulate a flow of electrical energy to a resonant load;
providing each of the plurality of switches with a diode connected in anti-parallel to its respective switch; and
generating a voltage-modulated waveform across the resonant load which results in a first amount of loss energy distributed equally among the plurality of switches, and a second amount of loss energy distributed equally among the diodes.

2. The method of claim 1, wherein implementing the voltage-modulated waveform across the resonant load comprises implementing the voltage-modulated waveform across the resonant load using an H-bridge circuit having a left leg and a right leg, wherein the resonant load is connected to respective central junctions of the left and right legs.

3. The method of claim 2, wherein implementing the voltage-modulated waveform across the resonant load using an H-bridge circuit comprises generating a first voltage waveform at the central junction of the left leg, and generating a second voltage waveform at the central junction of the right leg, wherein the second voltage waveform is a mirrored pattern of the first voltage waveform.

4. The method of claim 2, wherein using a plurality of switches to modulate a flow of electrical energy to a resonant load comprises using four switches to modulate a flow of electrical energy to a resonant load.

5. The method of claim 1, further comprising the step of using a controller configured to control the plurality of switches and programmed to generate the first voltage waveform and the second voltage waveform.

6. The method of claim 1, wherein using a plurality of switches to modulate a flow of electrical energy to a resonant load comprises using a plurality of switches to modulate a flow of electrical energy to an ozone generator.

7. The method of claim 1, wherein using a plurality of switches to modulate a flow of electrical energy to a resonant load comprises using a plurality of transistors to modulate a flow of electrical energy to a resonant load.

8. A drive circuit for driving a resonant load, the drive circuit comprising:
a plurality of switches to modulate a flow of electrical energy to a resonant load, each of the plurality of switches having a diode connected in anti-parallel;
a resonant load coupled to the switches such that the switches modulate a flow of electrical energy to the resonant load; and
a controller coupled to the switches, the controller configured to operate the plurality of switches such that a first amount of loss energy is distributed equally among the plurality of switches, and a second amount of loss energy is distributed equally among the diodes.

9. The drive circuit of claim 8, wherein the plurality of switches and associated diodes are arranged to form an H-bridge circuit with a left leg and a right leg, the resonant load being connected to respective central junctions of the left and right legs.

10. The drive circuit of claim 9, wherein the plurality of switches includes no more than four switches.

11. The drive circuit of claim 8, wherein the controller is configured to operate the plurality of switches to generate a first voltage waveform at the central junction of the left leg, and to generate a second voltage waveform at the central junction of the right leg, wherein the second voltage waveform is a mirrored pattern of the first voltage waveform.

12. The drive circuit of claim 8, wherein the resonant load is an ozone generator.

13. The drive circuit of claim 8, wherein the plurality of switches comprises a plurality of transistors.

14. The drive circuit of claim 13, wherein the plurality of transistors comprises a plurality of insulated-gate bipolar transistors.
